(19) United States
(12) Patent Application Publication
(10) Pub. No.: US 2014/0166902 A1
(43) Pub. Date: Jun. 19, 2014

(54) Wavelength Conversion Body And Method For Manufacturing Same

(71) Applicants: Dirk Berben, Herdecke (DE); Ulrich Hartwig, Berlin (DE); Frank Jermann, Koenigsbrunn (DE); Nico Morgenbrod, Berlin (DE)

(72) Inventors: Dirk Berben, Herdecke (DE); Ulrich Hartwig, Berlin (DE); Frank Jermann, Koenigsbrunn (DE); Nico Morgenbrod, Berlin (DE)

(21) Appl. No.: 14/236,593

(22) PCT Filed: Jun. 25, 2012
(86) PCT No.: PCT/EP2012/062245

§ 371 Date: Jan. 31, 2014

(30) Foreign Application Priority Data
Aug. 1, 2011 (DE) 102011080179.0

(51) Int. Cl. F21V 9/16

(52) U.S. Cl. CPC F21V 9/16
USPC 250/458.1; 29/428

(57) ABSTRACT

A wavelength conversion body (1; 11) for generating wavelength-converted light (S) from primary light (P) shone into the wavelength conversion body (1; 11), comprising: a light guide body (2; 12) which is optically transmissive for the primary light (P) and the wavelength-converted light; (S), and at least one phosphor body (6; 16) having a phosphor, wherein the light guide body (2; 12) is monolithically connected to the at least one phosphor body (6; 16).

The invention relates to a wavelength conversion body for generating wavelength-converted light from primary light shone into the wavelength conversion body. The invention furthermore relates to a method for producing a wavelength conversion body.

In LARP (Laser Activated Remote Phosphor) applications, a phosphor is exposed to primary light by means of a laser. The phosphor converts at least some of the primary light into wavelength-converted light, typically into light with a longer wavelength (down-converting). The energy difference between the primary light and the wavelength-converted light is given off as Stokes heat, which leads to heating of the phosphor. This heating of the phosphor can in turn lead to a shift of a wavelength or peak wavelength of the wavelength-converted light (Stokes shift), a reduction of a quantum efficiency (quantum degradation) and a reduced lifetime.

One possibility for better heat reduction from a phosphor consists in positioning the phosphor in a window of a rotating light wheel, the window being exposable to the laser. By cyclic rotation of the window in and out through the laser beam, a time-average exposure and therefore heat development is limited. The use of a light wheel, however, is relatively elaborate and not very effective, and does not permit continuous generation of the wavelength-converted light.

Another possibility consists in improving heat removal from the phosphor by providing low thermal resistance between the phosphor and a heat sink. For example, the phosphor may be embedded in waterglass. A phosphor layer is also configured as thinly as possible. In this case, the phosphor layer lies between the laser and the heat sink and itself constitutes a thermal barrier.

It is the object of the present invention to at least partially overcome the disadvantages of the prior art and, in particular, to provide a wavelength conversion body which combines good heat dissipation from a phosphor with a high luminous efficiency.

This object is achieved according to the features of the independent claims. Preferred embodiments may, in particular, be found in the dependent claims.

The object is achieved by a wavelength conversion body (i.e. a body for generating wavelength-converted light from primary light shone into the wavelength conversion body), having a light guide body or light guide region which is optically transmissive for the primary light and the wavelength-converted light, and at least one phosphor body or phosphor region having a phosphor, wherein the light guide body is monolithically connected to the phosphor body.

By virtue of the monolithic connection, a particularly stable wavelength conversion body is provided, which furthermore no longer has, or no longer has significant, thermal resistance between the light guide body on the one hand and the at least one phosphor body on the other hand. The light guide body may be used as a thermal conduction body or heat sink, so that the at least one phosphor body can also be cooled with the same effectiveness. Since the light guide body is optically transmissive both for the primary light and for the wavelength-converted light, the light guide body can be arranged between a light source emitting the primary light and the at least one phosphor body. In this way, the phosphor of the at least one phosphor body does not act as a thermal barrier, which further facilitates heat limitation. In particular, the primary light can thus be shone into the light guide body and guided by the light guide body to the at least one phosphor body. There, the primary light is at least partially wavelength-converted and at least the wavelength-converted light is subsequently output from the light guide body and consequently from the wavelength conversion body.

The light guide body is, in particular, transparent for the primary light and/or the wavelength-converted light.

The at least one phosphor body may comprise one or a plurality of phosphors. The plurality of phosphors may, for example, convert the primary light into wavelength-converted light of a different color (for example with a different peak wavelength). Thus, in one refinement, the at least one phosphor body may be precisely one phosphor body which, in particular, comprises precisely one phosphor. This refinement may be particularly suitable for converting blue primary light partially into yellow light and thus generating blue/yellow mixed light, which overall has a white color. It is, however, also possible for example for a plurality of phosphor bodies which comprise different phosphors to be provided, since mutual influencing of the phosphors can be suppressed in this way.

In what follows, a phosphor is intended in particular to mean a luminescent material which contains one or more host lattices and activators bound therein, and optionally also stabilizers. The structure and mode of action of a phosphor are well known and need not be further discussed here. In order to produce the phosphor body, phosphor per se (for example with its own host lattice) may be added to a base material. It is also possible to add an activator, which is incorporated into the lattice of the base material of the phosphor body as the host lattice. In what follows, a phosphor may be understood as at least one activator or activator element. In particular, depending on the context, a phosphor may be understood as an activator incorporated in a host lattice or an activator per se (or precursor materials thereof), unless otherwise explicitly mentioned. The phosphor may furthermore comprise at least one sensitizer (or a precursor material thereof).

In general, the light guide body and the at least one phosphor body may also be understood and referred to as a light guide region, or as at least one phosphor region of the wavelength conversion body.

The light guide body may, in particular, be a body which guides light on the basis of total internal reflection (TIR body).

The light guide body may, for example, be provided in the form of an optical concentrator, particularly in the form of a CPC (Compound Parabolic Concentrator) body.

It is one configuration that the light guide body has a light entry surface for entry of the primary light and a light exit surface for exit at least of the wavelength-converted light, and the at least one phosphor body is arranged optically downstream of the light entry surface. Consequently, the primary light first enters the light entry surface, is guided through the light guide body to the at least one phosphor body, and is at least partially converted therein into wavelength-converted light by means of at least one phosphor, and at least the wavelength-converted light is output at the light exit surface. That the at least one phosphor body is arranged optically downstream of the light entry surface includes the at least one light guide body being arranged at a distance from the light entry surface. This in turn reinforces effective light output.

For the case in which the light guide body is provided in the form of a CPC body, it is a preferred refinement that the light entry surface corresponds to a larger end surface of the two end surfaces, and the at least one phosphor body is arranged on the smaller end surface of the two end surfaces.

It is another configuration that the light entry surface and the light exit surface coincide at least in regions, and at least one phosphor body is arranged opposite the light entry surface. In this way, a particularly simply configured and robust light guide body, and consequently also wavelength conversion body, is provided. A coinciding region of the light entry surface and of the light exit surface may also be referred to as a light transmission surface. The light entry surface and the at least one phosphor body may, in particular, be provided at opposite ends of the light guide body, which permits simple shaping and effective exposure of the at least one phosphor body to the primary light.

For the case in which the light guide body is provided in the form of a CPC body, it is a preferred refinement that the light transmission surface corresponds to the larger end surface of the two end surfaces, and the at least one phosphor body is arranged on the smaller end surface of the two end surfaces, or a part thereof.

It is yet another configuration that the at least one phosphor body is covered with an (outer) reflective cover. This ensures that wavelength-converted light returns fully into the light guide body, so that a luminous efficiency of the wavelength-converted light is high and, in particular, it can shine through the light transmission surface with high efficiency.

The reflective cover may be specularly or diffusely reflective. A diffusely reflective cover offers the advantage that infinite passes are avoided. There are then no closed light paths in the wavelength conversion body, since the diffuse reflectivity breaks these light paths. Furthermore, thermal connection of such a reflector is not relevant since it does not contain any optically active material.

It is one refinement that the specularly reflective reflector is formed by means of a reflective layer. For example, the specularly reflective reflector may be formed by means of application, in particular vapor deposition, of a metallic or dielectric mirror layer.

It is another refinement that the diffusely reflective reflector comprises a strongly scattering material, for example titanium dioxide, embedded in a binder or in a matrix.

For mechanically stable and optically transmissive connection between the light guide body and the at least one phosphor body, it is a generally advantageous refinement that the bodies have an identical base material. In particular, the light guide body may consist of the base material (without phosphor), and the at least one phosphor body may consist of a base material to which phosphor is added. Thus, in particular, a material mismatch at the interface between the bodies during sintering can be suppressed or even entirely avoided.

It is furthermore a configuration that the light guide body (or region) and the at least one phosphor body (or region) are or contain garnet-based bodies. A garnet-based body can be produced so as to be optically transmissive, in particular transparent (scattering-free) and furthermore provided or supplemented with phosphor in a controlled way. In particular, a garnet-based body can be doped with an activator of a phosphor, the base material (the garnet or garnetoid) providing the host lattice. A garnet-based body is furthermore highly thermally conductive. Besides single-crystal growth, a garnet-based body can advantageously also be produced by sintering.

The base material of the garnet-based body or bodies may, in particular, comprise YAG, YAGaG, LuAG or LuAGaG, etc.

It is another configuration that the light guide body is an (optically transmissive) ceramic light guide body, and the at least one phosphor body comprises at least one ceramic phosphor body. A ceramic is highly thermally conductive and robust.

It is also a configuration that the light guide body and the at least one phosphor body are bodies cleaved to one another. The wavelength conversion body may in this case, in particular, be produced by producing the light guide body and the at least one phosphor body separately, smoothing a respective contact surface of the bodies and bringing the light guide body and the at least one phosphor body together on their contact surfaces.

It is one refinement that the two contact surfaces, or facets, to be joined are planarized, in particular plane-polished. When these contact surfaces are brought very close together, bonding of the bodies on the basis of van der Waals forces takes place (so-called vacuum welding). In order to reinforce the bonding, the contact surfaces may be coated beforehand at least partially with different materials in order to form a very thin layer (ideally a monolayer), the outer side of which contains a high density of hydrogen atoms. When these coated sides are brought together and heated, hydrogen bridges are formed. This method is referred to as hydrogen bonding. In both cases, the assembled bodies are almost monolithic.

It is another refinement that at least one sintered phosphor body is cleaved onto a light guide body grown in a monocrystalline fashion. It is furthermore a refinement that at least one phosphor body grown in a monocrystalline fashion is cleaved onto a light guide body grown in a monocrystalline fashion.

It is an alternative configuration that the light guide body and the at least one phosphor body are or contain sintered bodies sintered together. In the case of sintering, planarization can be obviated.

The production may, in particular, comprise at least the following steps: introducing a slip of a green body of the light guide body or of the at least one phosphor body into a mold; subsequently introducing a slip of a green body of the respective other body into the mold; and sintering the combined green body.

In particular, such a wavelength conversion body may be obtained by joining the green bodies before sintering. If, for example, to this end slip is poured into a mold, then advantageously an (in particular thin) layer of green body material of the at least one phosphor body, to which phosphor (activator with or without host lattice) or phosphor precursor material is added, is advantageously introduced first and dried. The rest of the mold can subsequently be filled at least partially with undoped, or phosphor-free, green body material. The sequence of the introduction of the slip is not restricted, and is determined above all by the shape of the wavelength conversion body. The (overall) green body obtained in this way is subsequently compacted by sintering. As a result, a wavelength conversion body having a light guide body, to which at least one thin layer of phosphor body is monolithically connected, is obtained.

It is another preferred configuration that the light guide body and the at least one phosphor body are or contain nitride-based bodies. A nitride-based ceramic has nitrogen as a main constituent, for example AlN, SiN or AlSiN. Nitride-based ceramics have the advantage that they can be produced in optically transmissive, for example translucent, variants.

It is a particularly preferred configuration that at least the light guide body consists of sialon. Sialon is a mixed ceramic of Si₃N₄, Al₂O₃ and AlN (SiAlON). Sialons have an improved sintering behavior compared with a pure nitride-based ceramic, in particular a lower sintering temperature at atmospheric pressure. Of the various modifications of sialon, so-called α-sialon is preferred here, inter alia owing to its optical transmissivity. Thus, a dense transparent ceramic can be produced from a green body by sintering at about 1950° C. in a nitrogen atmosphere.

A sialon having a relatively low proportion of Al₂O₃ is particularly preferred.

The green body may comprise sintering aids, for example based on alkaline-earth metals and/or rare earths.

It is furthermore a configuration that at least one phosphor comprises the activators or activator elements Eu, Ce, Yb, Mn and/or Nd. These activators can readily be incorporated and accurately dosed into many ceramics and garnet-based bodies. For instance, Eu typically gives amber-colored wavelength-converted light and Ce gives emission of yellow wavelength-converted light. Yellow wavelength-converted light is also obtained, for example, from Eu, Yb and Mn.

For example, a garnet-based body per se may be used as a host lattice and supplemented, in particular doped, with at least one activator, in particular Ce, for example to give YAG:Ce.

In order to introduce the phosphors into a sintered ceramic body, for example, suitable precursor materials, for example oxides, nitrides or fluorides of the phosphors may be added to the green body. In the case of a sialon, for example, if Eu is provided as an activator, the corresponding oxides (Eu₂O₃, etc.), fluorides (EuF₃) or nitrides (EuN) and the like may be added to the green body. During the sintering process, Eu as an activator is reduced etc. and, for example, is present as Eu²⁺ in the finished ceramic body. In a similar way, for example, Ce³⁺, Yb²⁺, Mn²⁺, etc. may be introduced as activators. A sialon, in particular α-sialon, per se may also already be a wavelength-converting substance. In the case of a ceramic, an activator may be incorporated into the lattice of the ceramic as a host lattice, or a (finished) phosphor which has or produces its own host lattice may be added to the ceramic (respectively before the sintering, or the like, and in particular also a suitable precursor material).

The invention is not, however, restricted to systems in which the light guide body and the at least one phosphor body are formed from sialons. For instance, merely the light guide body may consist of sialon and the at least one phosphor body may consist of another nitride-based ceramic. In this case, use is made of the fact that a lattice mismatch of nitride-based ceramics is rather low.

It is preferred that a material of a nitride-based ceramic supplemented or doped with phosphor and supplemented with Ca as the activator comprises AlSiN or SiAlN, in particular CaAlSiN or CaSiAlN.

The above-described properties, features and advantages of this invention, and the way in which they are achieved, will become more clearly and readily comprehensible in conjunction with the following schematic description of exemplary embodiments, which will be explained in more detail in connection with the drawings. For the sake of clarity, elements which are the same or have the same effect may be provided with the same references.

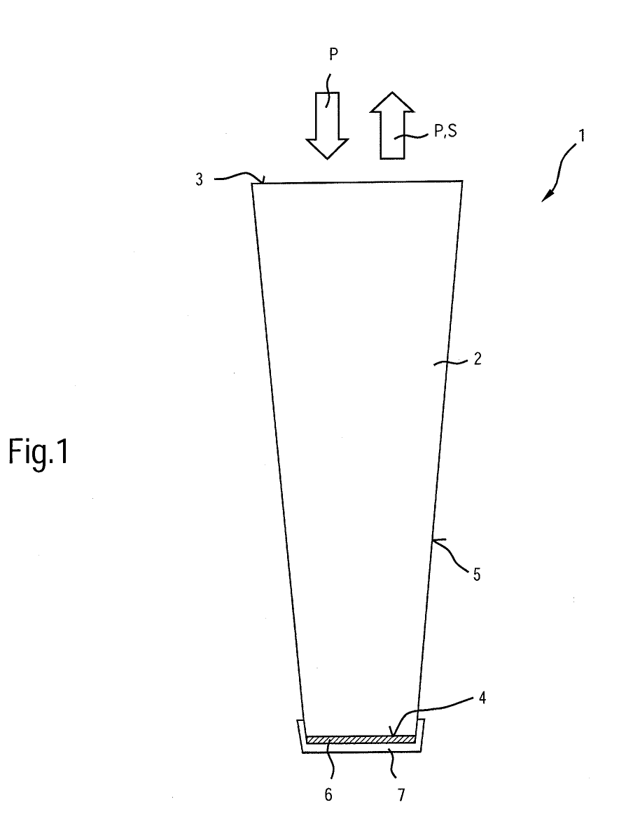

FIG. 1 shows a wavelength conversion body according to a first exemplary embodiment as a sectional representation in side view; and

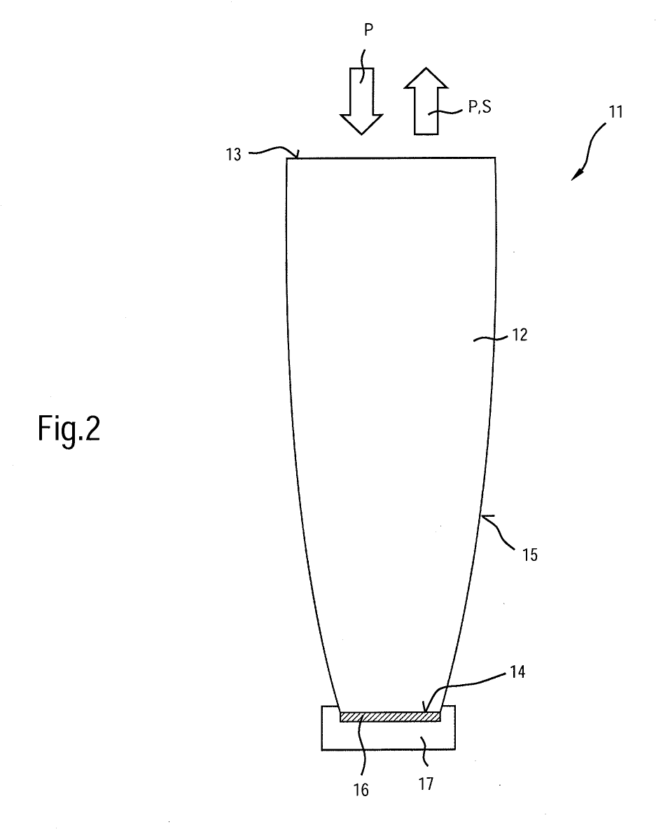

FIG. 2 shows a wavelength conversion body according to a second exemplary embodiment as a sectional representation in side view.

FIG. 1 shows a wavelength conversion body 1 according to a first exemplary embodiment as a sectional representation in side view. The wavelength conversion body 1 is used in order to generate wavelength-converted light from primary light P shone into the wavelength conversion body 1.

The primary light P may, for example, be laser light generated by a laser or narrowband light generated by a light-emitting diode. However, the type of light source generating the primary light P is in principle not restricted and may, for example, also comprise a broadband-emitting light source with or without a downstream filter, or a discharge lamp with line emission or a pressure-broadened wavelength emission range. A corpuscular beam (for example an electron beam or an ion beam) may also be used.

The wavelength conversion body 1 has a light guide body 2 which is optically transmissive, in particular transparent, for the primary light P. The light guide body 2 in this case has the shape of a conical frustrum with a larger end surface 3, a smaller end surface 4 and a lateral surface 5. The larger end surface 3 is used as a light entry surface for entry of the primary light P. The light guide body 2 is configured as a TIR body, so that primary light P shone in on the larger end surface 3 is guided to the smaller end surface 4 directly or by means of total internal reflection.

The smaller end surface 4 is covered with a phosphor body 6, the light guide body 2 and the phosphor body 6 being monolithically connected to one another. The phosphor body 6 is formed as a thin disk-shaped body of an optically transparent base material, to which for example Eu or Ce is added as an activator. The primary light P thus enters the phosphor body 6 and is at least partially converted therein into wavelength-converted (secondary) light S. The phosphor body 6 is consequently arranged optically downstream of the larger end surface 3 used as the light entry surface, specifically in this case arranged opposite the larger end surface 3.

So that at least the wavelength-converted light S can be used expediently, the phosphor body 6 is covered with a specularly reflective cover 7 in the form of a metal layer applied externally onto the phosphor body 6. If the wavelength-converted light S and, where applicable, the primary light P have not already been emitted directly into the light guide body 2 by the phosphor body 6, they are reflected back into the light guide body 2 by means of the reflective cover 7. The light guide body 2 is also optically transmissive, in particular transparent, for the wavelength-converted light S. Light entering the light guide body 2 from the phosphor body 6 through the smaller end surface 4 can be output from the light guide body 2 at the larger end surface 3. The larger end surface 3 is consequently also used as a light exit surface, and therefore also as a combined light transmission surface. Owing to the opposite arrangement of the larger end surface 3 and the phosphor body 6, the phosphor body 6 does not impede output of the wavelength-converted light S from the wavelength conversion body 1.

Purely by way of example, the light guide body 2 and the phosphor body 6 are in this case formed as garnet-based bodies which, in particular, differ in that the phosphor body 6 is doped with an e.g. Ce- or Eu-activated phosphor. The light guide body 2 and the phosphor body 6 may, for example, have been connected to one another by sintering or cleaving. In the case of cleaving, the smaller end surface 4 of the light guide body and the side of the phosphor body 6 facing toward the smaller end surface 4 have been planarized and connected to one another as contact surfaces. In the case of sintering by using slips as green bodies, it is advantageous in terms of manufacturing technology that the slip for producing the phosphor body 6 is introduced first.

FIG. 2 shows a wavelength conversion body 11 according to a second exemplary embodiment as a sectional representation in side view. The wavelength conversion body 11 is constructed in a similar way to the wavelength conversion body 1. Here, however, the light guide body 12 approximately has a CPC shape with a larger end surface 13, a smaller end surface 14 and a lateral surface 15. The phosphor body 16 is in this case also arranged as a thin disk-shaped body on the smaller end surface 14 and monolithically connected to the light guide body 12.

The reflective cover 17 is configured here as a diffusely reflective cover 17, in order to avoid infinite light paths in the wavelength conversion body 11. The cover 17 may, for example, comprise diffusely reflective TiO₂ which is contained as a filler in a suitable binder material, for example silicone.

The light guide body 12 and the phosphor body 16 are in this case formed as sialon bodies, which differ in that a phosphor (for example containing Eu as an activator) is added to the phosphor body 16. The light guide body 12 and the phosphor body 16 may have been connected to one another, for example, by sintering or cleaving. In the case of cleaving, the smaller end surface 14 of the light guide body and the side of the phosphor body 16 facing toward the smaller end surface 14 have been planarized and connected to one another as contact surfaces. In the case of sintering by using slips as green bodies, it is advantageous in terms of manufacturing technology here as well that the slip for producing the phosphor body 16 is introduced first.

Although the invention has been illustrated and described in detail by the exemplary embodiments presented, the invention is not restricted thereto and other variants may be derived therefrom by the person skilled in the art, without departing from the protective scope of the invention.

For instance, the wavelength conversion body 1 may also consist of a ceramic and the wavelength conversion body 11 may be a garnet-based body. A specularly or diffusely reflective cover may also be used in both exemplary embodiments. Furthermore, the shape of the light guide body or of the wavelength conversion body is not restricted to the shapes shown.

1. A wavelength conversion body for generating wavelength-converted light from primary light shone into the wavelength conversion body, comprising:
a light guide body which is optically transmissive for the primary light and the wavelength-converted light; and
at least one phosphor body having a phosphor,
wherein the light guide body is monolithically connected to the at least one phosphor body.

2. The wavelength conversion body as claimed in claim 1, wherein:
the light guide body has a light entry surface for entry of the primary light and a light exit surface for exit at least of the wavelength-converted light, and
the at least one phosphor body is arranged optically downstream of the light entry surface.

3. The wavelength conversion body as claimed in claim 2, wherein the light entry surface and the light exit surface coincide at least in regions, and at least one phosphor body is arranged opposite the light entry surface.

4. The wavelength conversion body as claimed in claim 1, wherein the at least one phosphor body is covered with a specularly or diffusely reflective cover.

5. The wavelength conversion body as claimed in claim 1, wherein the light guide body and the at least one phosphor body are or contain garnet-based bodies.

6. The wavelength conversion body as claimed in claim 1, wherein the light guide body is a ceramic light guide body, and the at least one phosphor body comprises at least one ceramic phosphor body.

7. The wavelength conversion body as claimed in claim 6, wherein the light guide body and the at least one phosphor body are bodies cleaved to one another.

8. The wavelength conversion body as claimed in claim 6, wherein the light guide body and the at least one phosphor body are sintered bodies sintered together.

9. The wavelength conversion body as claimed in claim 6, wherein the light guide body and the at least one phosphor body are or contain nitride-based bodies.

10. The wavelength conversion body as claimed in claim 9, wherein at least the light guide body consists of or contains sialon.

11. The wavelength conversion body as claimed in claim 1, wherein at least one phosphor comprises Eu, Ce, Yb, Mn and/or Nd.

12. A method for producing a wavelength conversion body as claimed in claim 7, wherein the method comprises the following steps:
producing the light guide body;
producing the at least one phosphor body;
smoothing a respective contact surface of the light guide body and of the at least one phosphor body; and
bringing the light guide body and the one phosphor body together on their contact surfaces.

13. A method for producing a wavelength conversion body as claimed in claim 8, wherein the method comprises the following steps:
introducing a slip of a green body of the light guide body or of the phosphor body into a mold;
subsequently introducing a slip of a green body of the respective other body (6, 2; 16, 12) into the mold; and
sintering the combined green body.
